(19) United States
(12) Patent Application Publication
(10) Pub. No.: US 2022/0076600 A1
(43) Pub. Date: Mar. 10, 2022

(54) METHOD FOR VALIDATING ENVIRONMENTAL IMAGE DATA, APPARATUS, COMPUTER PROGRAM, AND COMPUTER-READABLE STORAGE MEDIUM

(71) Applicant: Continental Automotive GmbH, Hannover (DE)

(72) Inventor: Torsten Lahr, Zornheim (DE)

(73) Assignee: Continental Automotive GmbH, Hannover (DE)

(21) Appl. No.: 17/416,124

(22) PCT Filed: Dec. 11, 2019
(86) PCT No.: PCT/EP2019/084621

§ 371 Date: Jun. 18, 2021

(30) Foreign Application Priority Data
Dec. 20, 2018 (DE) 10 2018 222 493.5

(51) Int. Cl. G09G 3/00; G06K 9/62; H04N 7/18; H04N 5/232

(52) U.S. Cl. CPC G09G 3/006; G06K 9/6202; G09G 2380/10; H04N 5/23229; G09G 2330/12; H04N 7/183

(57) ABSTRACT

A method for validating transmitted image data comprises providing image data and transmitting the image data to a display unit, providing reference image data, comparing the transmitted image data to the reference image data by means of a cross-correlation in a comparison unit as to whether the reference image data are present in the transmitted image data, creating a comparison probability value on the basis of the comparison, displaying the transmitted image data on the display unit if the comparison probability value lies above a provided, predefined limit probability value, and outputting a substitute response if the comparison probability value lies below the provided, predefined limit probability value.

### CROSS-REFERENCE TO RELATED APPLICATIONS

This U.S. patent application claims the benefit of PCT patent application No. PCT/EP2019/08462135, filed Dec. 11, 2019, which claims the benefit of German patent application No. 10 2018 222 493.5, filed Dec. 20, 2018, both of which are hereby incorporated by reference.

### TECHNICAL FIELD

The invention relates to a method for validating transmitted image data, in particular in a motor vehicle, as well as a display unit. The invention relates in particular to the reliable representation of safety-relevant information on a display unit. The invention further relates to a computer program and a computer-readable storage medium.

### BACKGROUND

In a vehicle it is important, in the case of safety-relevant information such as, for example, warning symbols that the correct information is represented on a display. Specific standards such as, for example, ISO 26262 have been introduced for this purpose for electronic or electrical systems in motor vehicles.

An actual checksum for a CRC (cyclic redundancy check) is calculated over a defined image region for the recognition of warning symbols. This checksum is subsequently compared with a calculated target checksum. The symbol is considered as recognized if there is precise agreement.

In this method, if there is a minimal change to an image region to be checked, for example a different color representation or a different background in the region of the warning symbol, it is necessary to calculate a new target CRC checksum in order to avoid the target CRC checksum differing from the actual CRC checksum, causing an error to be reported although no such error is present.

EP 2273369 B1 discloses a method for the secure representation of safety-relevant information, comprising: inputting at least one input variable into a computing unit, computer processing the input variable in the computing unit to form an image data sequence representing the input variable, passing the image data sequence to a display unit and representing the image data sequence on the display unit, supplying the image data sequence to a check unit and carrying out a safety check through computer creation of a check code for the image data sequence, comparing the check code with a plurality of comparison codes present in the check unit, assigning the comparison code ascertained in this way to a corresponding possible value of the input variable and comparing it with the value of the input variable for the formation of either a positive or negative test result in the check unit to initiate a safety-oriented response. A pre-calculated CRC checksum is used here as the comparison code.

DE 102007048608 A1 discloses a method for checking a validity of display signals, wherein the display signals are generated from image data of a predefined image, wherein a defined region of image data is ascertained from the display signals, wherein a check value is formed from the ascertained image data, wherein the ascertained check value is compared with a stored check value for the corresponding image, and wherein a validity of the display signals is only determined if the ascertained and stored check values are in accord.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

It is an object of the invention to facilitate validating in the case of image data transmitted as an input variable and represented on a display unit.

A method for validating transmitted image data has the steps of: providing image data and transmitting the image data to a display unit, providing reference image data, and comparing the transmitted image data to the reference image data by means of a cross-correlation in a comparison unit as to whether the reference image data are present in the transmitted image data, creating a comparison probability value on the basis of the comparison, displaying the transmitted image data on the display unit if the comparison probability value lies above a provided, predefined limit probability value, outputting a substitute response if the comparison probability value lies below the provided, predefined limit probability value.

The term “display unit” may refer to the display unit of a vehicle. This can, for example, be the display of an entertainment system. The generation of the image data and the transmission can, for example, be provided in a processor of the vehicle and/or in a control unit. The comparison unit can be an electronic unit that is designed to receive image data and to compare them with reference image data.

The term “image data” can here refer to pixels that can be represented on the display unit. The pixels can be divided into subpixels/illuminant pixels, each of which has, for example, one of the three additive primary colors red, green and blue (RGB system). The image data thus may comprise specifications of how the individual pixel is to be represented. In general, image data comprise information for the display device that enables it to represent the image data visually.

The image data can be information for the display of a warning symbol/symbol or a sign or a notification (for example a gas pump symbol) or can represent weather information (caution, snowfall).

The limit probability value can, for example, be specified by the manufacturer.

The expression “above a provided, predefined limit probability value” can also include “equal to a provided, predefined limit probability value”.

The transmission of data can take place over cables or wirelessly.

The method explained here tolerates minor transmission errors and changes to the image data as a result of signal processing. Reliable recognition of the image data is still ensured even when lossy compression is used to reduce the transmission bandwidth. By checking a larger monitoring region, a minor shift in the symbols/signs can be tolerated.

The method can ignore smaller errors in the image data, provided the image data are still recognizable. The method is independent of changes in position that arise, for example, from calibrating the image data against a mechanical framework. The image data are recognized independently of the background, provided they clearly differ from it. The image data are reliably discovered by the method. A premature substitute response, for example switching off the display unit, is avoided.

The method may be suitable for use in a motor vehicle.

The cross-correlation may be configured as a normalized cross-correlation or a non-normalized cross-correlation or a feature-based cross-correlation or a pixel-based cross-correlation.

In one configuration, a characteristic feature is added to the image data. The transmitted image data can in this way be checked more easily.

The image data may be designed as an identifier. The identifier is added to camera data (image) that are recorded from a sensor.

The identifier can be a unique, invisible pattern, for example a digital fingerprint in the form of a checksum or another unique marking which is for example added to camera data/video data recorded by a sensor. Using cross-correlation, the image data are then checked for the presence of the identifier, for example of the checksum. Through the introduction of the identifier, such as alternating or changing identifiers at the same position, the camera data/video data represented on the display unit can be monitored for freezing.

The limit probability value may be weighted with reference to different image data. Thus, for example, image data that represent warning notices relating to driving safety can be given a higher limit probability value than warning notices with lower safety relevance.

The substitute response may comprise the complete or partial switching off of the display unit. In a particular embodiment, the substitute response comprises the display of an error message on the display unit and/or the output of a signal and/or of textual information.

It can be ensured in this way that the user, for example the driver of the vehicle, is not disturbed or wrongly informed by incorrectly displayed image data.

The switching off can entail switching off the illumination of the display unit and/or ending the representation of the image data on the display unit. A reset of the display unit can also be carried out. This can also, simultaneously or alternatively, be an audible error message, for example a warning tone.

The object is further achieved by means of the disclosure of a display unit comprising a comparison unit that is designed to compare transmitted image data with reference image data, as to whether the reference image data are present in the transmitted image data, wherein the comparison unit is designed to carry out the comparison by means of cross-correlation and, on the basis of the comparison, to create a comparison probability value, wherein the display unit is designed to display the transmitted image data if the comparison probability value lies above a provided, predefined limit probability value, and to output a substitute response if the comparison probability value lies below the provided, predefined limit probability value.

The display unit is in particular designed to carry out the method as described above.

The invention may further relate to a vehicle with a display unit as described above. The vehicle may be designed as a passenger motor vehicle.

The object is furthermore achieved by means of the disclosure of a computer program comprising commands that have the effect that the display unit as described above carries out the method as described above. The object is further achieved by means of the disclosure of a computer-readable storage medium on which the computer program as described above is stored. The method may thus also be retroactively installed in, for example, a vehicle.

Therefore, a method, a display unit, a vehicle, a computer program and a computer-readable storage medium are provided for validating transmitted image data in which the transmitted image data can be represented reliably and robustly, and a premature substitute response can be avoided. The represented contents can be symbols, barcodes, fingerprints, characters and so forth.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

Further features, properties and advantages of the present invention emerge from the following description with reference to the attached figures, in which:

FIG. 1: shows schematically a flow diagram of a method according to the invention in a first configuration,

FIG. 2: shows schematically a flow diagram of a method according to the invention in a second configuration,

FIG. 3: shows schematically transmitted image data as an identifier on a display unit according to the invention, and

FIG. 4: shows schematically a vehicle according to the invention.

### DETAILED DESCRIPTION

Although the invention has been described and illustrated in more detail through the preferred exemplary embodiments, the invention is not limited by the disclosed examples. Variations thereof may be derived by a person skilled in the art without departing from the scope of protection of the invention as is defined by the following patent claims.

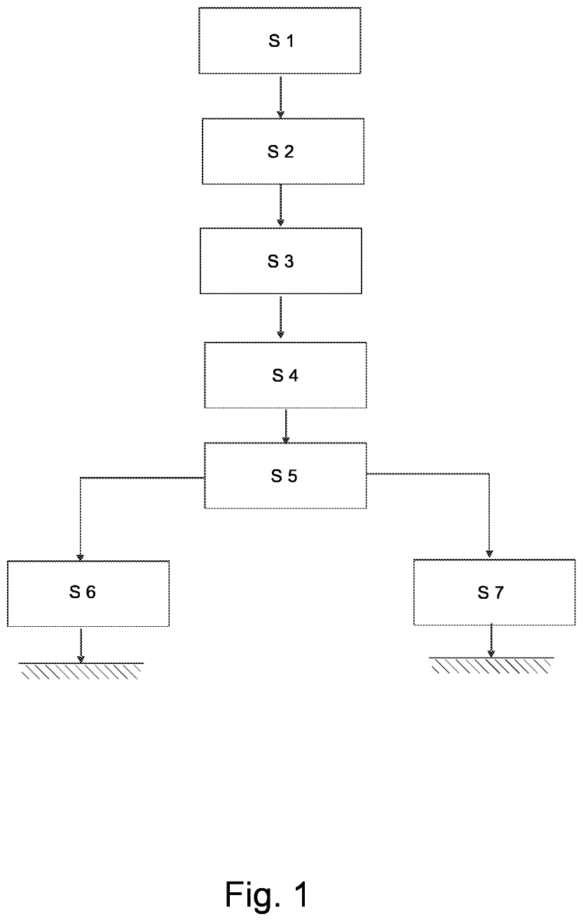

FIG. 1 shows a method in a first configuration. In a first step S1 here image data are selected, by a control unit 4 (FIG. 4) in a driver assistance system 3 (FIG. 4). The image data are here assigned to pixels of a display unit 2 (FIG. 4). The pixels can be divided into subpixels/illuminant pixels, each of which has one of the three additive primary colors red, green and blue (RGB system). In the RGB system, the color components for red, green and blue are stored separately for each pixel. The proportional quantity of red, green and blue determines the final color. Other representations are also possible.

The image data thus comprise specifications of how the individual pixel is to be represented. In general, image data comprise information for the display device that enables it to represent the image data visually.

The image data can be information for the display of a warning symbol/symbol or a sign or a notification (for example a gas pump symbol) or can represent weather information (caution, snowfall).

In a second step S2 the image data are transmitted to a comparison unit 5 (FIG. 4) that comprises, for example, a graphics chip. This transmission can be effectuated wirelessly or by means of a wired connection. A wireless transmission can, for example, comprise W-LAN, Bluetooth or infrared transmission.

Other camera image data can further also be provided for display purposes (a roadmap, for example) or an image of the surroundings, wherein these camera image data are also converted into pixels for representation on the display unit (FIG. 4). The transmitted image data are then to be represented with these camera image data on the display unit 2 (FIG. 4). The transmitted image data can, however, also be represented alone.

In a third step S3, the image data transmitted to the display unit 2 (FIG. 4) are compared with stored reference image data. This is done with the aid of a comparison unit 5 (FIG. 4), which may be integrated into the display unit 2 (FIG. 4). The region of the image segment in which the transmitted image data lie is extracted for this purpose from the received data stream. The transmitted image data that lie in the region of the image segment to be investigated are compared to the reference image data using a cross-correlation (method). The stored reference image data can here be stored in the display unit 2 (FIG. 4). The stored reference image data can here comprise a small selection of the actual image data preferably representing fixed points on the display unit 2 (FIG. 4).

The cross-correlation evaluates the difference between the reference image data and the transmitted image data. Cross-correlations are robust with respect to small disturbances such as noise. The cross-correlation can, for example, be calculated using the Fourier transform.

Cross-correlation can also refer to a cross-correlation method such as the binary pixel-based cross-correlation, or to a feature-list-based cross-correlation. The last one may be characterized by its speed, provided the noise level is low. A non-normalized cross-correlation can also be used. This is characterized by reduced computing effort and a lower memory usage. The normalized cross-correlation is also appropriate for the real-time method.

In a fourth step S4, a comparison probability value can now be determined on the basis of the cross-correlation that has been carried out as a result of the comparison, indicating the probability with which the reference image data are present in the transmitted image data.

In a fifth step S5, the comparison probability value determined in this way is compared with a predefined limit probability value.

If the comparison probability value is higher than the limit probability value, then in a sixth step S6 the transmitted image data are represented on the display unit 2 (FIG. 4). The term “higher” can also mean here that the comparison probability value is equal to the limit probability value. Alternatively, this is not included.

The limit probability value can also be specified here in a weighted manner. Thus, for example, image data that represent warning notices relating to driving safety, for example “Caution, ice”, can be given a higher limit probability value than warning notices with lower safety relevance.

If the comparison probability value is lower than the limit probability value, a substitute response is initiated in a seventh step S7. Such a response can, for example, entail switching off the display unit 2 (FIG. 4) which is usually a display of an entertainment system, or displaying a central error warning, or overlaying the reference image data onto the checked, transmitted image data.

Due to the method, minor changes, for example a different coloration or a different font size, can be tolerated, and do not lead to a false alarm. An image memory can thus, for example, be omitted.

The method tolerates minor transmission errors and changes to the image data as a result of signal processing. Reliable recognition of symbols/signs is still ensured even when lossy compression is used to reduce the transmission bandwidth. By checking a larger monitoring region, a minor shift in the symbols/signs can be tolerated.

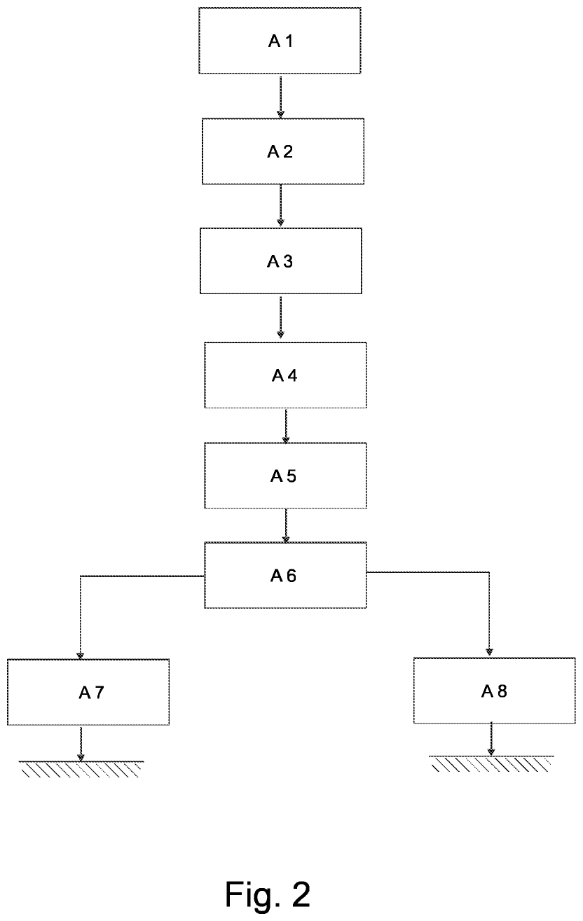

FIG. 2 shows another embodiment of the method.

As in FIG. 1, in a first step A1 here image data are selected, preferably by the control unit 4 (FIG. 4) in the driver assistance system 3 (FIG. 4).

In a second step A2 the image data are transmitted to a comparison unit 5 (FIG. 4) that comprises, for example, a graphics chip.

In a third step A3, a characteristic feature is added to the transmitted image data. The reference image data are formed on the basis of this characteristic feature. Multiple or different characteristic features can also be inserted.

In a fourth step A4, the image data transmitted to the display unit 2 (FIG. 4) are compared by means of the cross-correlation with the stored reference image data, and checked for the presence of the characteristic feature. The cross-correlation can thus be carried out more efficiently and effectively with reference to the characteristic feature. The required computing power can thereby also be lowered.

In a fifth step A5, the comparison probability value can be determined on the basis of the cross-correlation that has been carried out as a result of the comparison, indicating the probability with which the reference image data with the characteristic feature are present in the transmitted image data with the characteristic feature.

In a sixth step A6, the comparison probability value determined in this way is compared with a predefined limit probability value.

If the comparison probability value is higher than the limit probability value, then, in a seventh step A7, the transmitted image data with the characteristic feature are represented on the display unit 2 (FIG. 4).

If the comparison probability value is lower than the limit probability value, a substitute response is initiated in an eighth step A8.

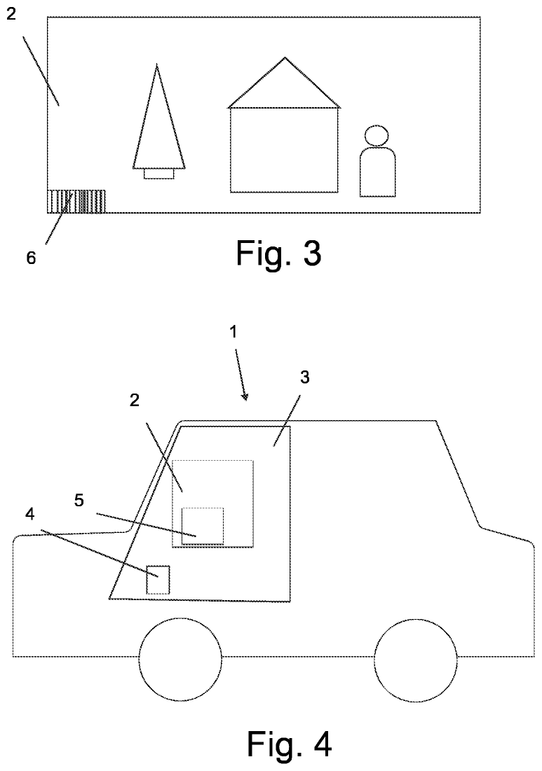

FIG. 3 shows a further configuration of the invention. The image data are represented here as an identifier 6. The identifier 6 is preferably designed as identification data.

Camera data, which can also be video data and are therefore referred to below as camera data/video data, have been recorded here by a camera, for example a sensor. These can represent a camera image/video image, for example of a vehicle environment. Camera data streams/video data streams that represent a sequence of camera/video images are preferably recorded. Camera data/video data here refer to any data recorded by, for example, a sensor.

The identifier 6 is added to the camera data/video data. FIG. 3 shows the camera data with the identifier 6 represented on the display unit 2. The identifier 6 can be a unique, invisible pattern, for example a digital fingerprint, that is added to the camera data/video data. The identifier 6 can here be inserted by computer-aided steganography, so that a user preferably does not notice the identifier 6. The identifier 6 can, however, also be an easy-to-identify barcode, a character, symbol or lettering. Other configurations are also possible.

The camera data/video data with the identifier 6 to be represented and transmitted to the display unit 2 are checked for a presence of the identifier 6 by means of cross-correlation.

The comparison probability value is created on the basis of the comparison as to whether the identifier 6 is present in the transmitted camera data/video data. A reference identifier was created by the identifier 6 in advance for this purpose.

If the comparison probability value lies above a provided, predefined limit probability value, the transmitted camera data/video data are represented on a display unit 2.

If the comparison probability value lies below the provided, predefined limit probability value, the substitute response is output.

Through the introduction of alternating or changing identifiers 6 at the same position, the camera data/video data represented on the display unit 2 can be monitored for freezing.

If the identifier 6 does not change over a certain period of time, the camera data/video data represented on the display unit 2 are evaluated as having frozen, and a substitute response, for example a warning symbol on the display unit 2, or switching off the display unit 2, is initiated. In addition, the source from which the camera data/video data originate can be ascertained.

In this way it is possible to check whether the image has frozen, and a substitute response can be initiated.

The identifier 6 can be added to the camera data/video data by means of an identifier apparatus in this case.

FIG. 4 shows a vehicle 1 with the display unit 2. The vehicle 1 is here may be designed as a passenger motor vehicle. The display unit 2 can here be integrated into a driver assistance system 3. The display unit 2 may be designed as a display. In addition, the display unit 2 also comprises a comparison unit 5.

The vehicle 1 further comprises a control unit 4 that, in the presence, for example, of a disturbance in the vehicle operation, for example as a result of a failing component, transmits the corresponding warning symbol to the comparison unit 5 in image data. The control unit 4 can also be integrated into the driver assistance system 3.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1-13. (canceled)

14. A method for validating transmitted image data comprising:
providing image data and transmitting the image data to a display unit;
providing reference image data;
comparing the transmitted image data to the reference image data with a cross-correlation in a comparison unit as to whether the reference image data are present in the transmitted image data;
creating a comparison probability value on the basis of the comparison;
displaying the transmitted image data on the display unit when the comparison probability value lies above a provided, predefined limit probability value; and
outputting a substitute response if the comparison probability value lies below the provided, predefined limit probability value.

15. The method as claimed in claim 14, wherein the cross-correlation is configured as a normalized cross-correlation or a non-normalized cross-correlation or a feature-based cross-correlation or a pixel-based cross-correlation.

16. The method as claimed in claim 14, wherein a characteristic feature is added to the image data.

17. The method as claimed in claim 14, wherein the image data is designed as an identifier.

18. The method as claimed in claim 17, wherein the identifier is added to camera data that are recorded by a sensor.

19. The method as claimed in claim 14, wherein the limit probability value is designed in a weighted manner with reference to various image data.

20. The method as claimed in claim 14, wherein the substitute response comprises the complete or partial switching off of the display unit.

21. The method as claimed in claim 14, wherein the substitute response comprises at least one of: display of an error message on the display unit, output of a signal, and output of textual information.

22. A display unit comprising:
a comparison unit to compare transmitted image data with reference image data as to whether the reference image data are present in the transmitted image data, wherein the comparison unit is designed to carry out the comparison with cross-correlation and,
on the basis of the comparison, to create a comparison probability value,
wherein the display unit is designed to display the transmitted image data if the comparison probability value lies above a provided, predefined limit probability value, and
to output a substitute response if the comparison probability value lies below the provided, predefined limit probability value.

23. The display unit as claimed in claim 9 wherein the display unit is located in a vehicle

25. A computer-readable storage medium on which the computer program has instructions for validating transmitted image data comprising:
providing image data and transmitting the image data to a display unit;
providing reference image data;
comparing the transmitted image data to the reference image data with a cross-correlation in a comparison unit as to whether the reference image data are present in the transmitted image data;
creating a comparison probability value on the basis of the comparison;
displaying the transmitted image data on the display unit when the comparison probability value lies above a provided, predefined limit probability value; and
outputting a substitute response if the comparison probability value lies below the provided, predefined limit probability value.

26. The computer-readable storage medium as claimed in claim 25, wherein the cross-correlation is configured as one of: a normalized cross-correlation, a non-normalized cross-correlation, a feature-based cross-correlation, and a pixel-based cross-correlation.

27. The method as claimed in claim 25, wherein a characteristic feature is added to the image data.

28. The method as claimed in claim 25, wherein the image data is designed as an identifier.

29. The method as claimed in claim 28, wherein the identifier is added to camera data that are recorded by a sensor.

30. The method as claimed in claim 25, wherein the limit probability value is designed in a weighted manner with reference to various image data.

31. The method as claimed in claim 25, wherein the substitute response comprises the complete or partial switching off of the display unit.

32. The method as claimed in claim 25, wherein the substitute response comprises at least one of: display of an error message on the display unit, output of a signal, and output of textual information.
